(19) United States
(12) Patent Application Publication
(10) Pub. No.: US 2022/0374632 A1
(43) Pub. Date: Nov. 24, 2022

(54) METHOD AND SYSTEM FOR QUICKLY ELIMINATING SIGNAL SPIKES OF STRUCTURAL HEALTH MONITORING IN CIVIL ENGINEERING

(71) Applicant: QINGDAO UNIVERSITY OF TECHNOLOGY, Qingdao, Shandong (CN)

(72) Inventors: Yunxia XIA, Qingdao (CN); Xianchun MENG, Qingdao (CN)

(73) Assignee: QINGDAO UNIVERSITY OF TECHNOLOGY, Qingdao, Shandong (CN)

(21) Appl. No.: 17/627,111

(22) PCT Filed: May 11, 2021
(86) PCT No.: PCT/CN2021/092989

§ 371 Date: Jan. 13, 2022

(30) Foreign Application Priority Data
Dec. 2, 2020 (CN) 202011390794.9

(51) Int. Cl. G06K 9/00

(52) U.S. Cl. CPC G06K 9/00516; G06K 9/0053; G06K 9/00536

(57) ABSTRACT

The present invention provides a method and a system for quickly eliminating signal spikes of structural health monitoring in civil engineering, including the following steps: (1) quickly identifying, by using a threshold method, a spike position in a time domain; (2) extracting spike features in a time-frequency domain through wavelet transform for a signal within a set range near the spike position; and (3) eliminating spike feature components in wavelet coefficients, and effectively eliminating a spike through inverse wavelet transform. The method and system combine the advantages of a high calculation speed of a time domain method and high resolution of a time-frequency domain method, which can make an algorithm fast and accurate. In addition to eliminating a spike, the method and system also retain wanted signal components, and have good applicability to structural health monitoring signals in civil engineering with complex time-frequency characteristics and a large amount of data.

### TECHNICAL FIELD

The present invention relates to the field of structural health monitoring, and in particular, to a method and a system for quickly eliminating signal spikes of structural health monitoring in civil engineering.

### BACKGROUND

Structural health monitoring (SHM) is an effective technology to ensure the safety of civil engineering structures in service. Currently, hundreds of bridges, tunnels, high-rise buildings and other structures have been provided with SHM systems in the world. A large amount of data has been accumulated in these systems during operation over the years, and how to analyze a structural safety state based on the data is a core issue currently. However, due to occasional problems or errors in various modules of an SHM system, such as a sensing module, a data collection module, and a communication transmission module, inevitably there are singular components in an SHM signal. Because spikes are common singular components in an SHM signal, if not processed, the spikes may cause severe deviations in data-based structural state evaluation.

Methods for removing signal spikes can be divided into a time domain method, a frequency domain method, and a time-frequency domain method. If an absolute value or an instantaneous change of a spike in a time domain is significantly greater than other signals, the spike can be removed by a threshold method. A signal exceeding a threshold is replaced with a mean value, an interpolated value, or the like of adjacent signals. The method is simple and direct, and has a high calculation speed. A slope-based despiking method disclosed in the Chinese Patent Application No. CN111259311A belongs to this category. However, if a signal includes a wanted signal, the method may lead to loss of useful information. When having a shape obviously different from other signals, a spike can be removed by a template matching method. For example, the Chinese Patent Application No. CN109885903A discloses such a method. If frequency of a spike in a frequency domain is significantly greater than frequency of other signal components, the spike can be removed by a frequency filter. However, low-frequency components of a signal cannot be particularly low; otherwise, the Gibbs phenomenon is prone to occur during despiking.

However, time-frequency characteristics of an SHM signal in civil engineering are usually very complex, and are manifested in a variety of shapes and amplitudes, as well as a wide frequency range. A time domain method or a frequency domain method alone usually cannot effectively remove a spike thereof. A time-frequency method can be used to transform a signal to a time-frequency domain for refinement processing. For example, the Chinese Patent Application No. CN111650654A discloses a method for removing spikes in combination with the empirical mode decomposition (EMD) and wavelet transform (WT) algorithms to process a spike in the time-frequency domain. However, to grasp a structural safety state in time, real-time analysis of an SHM signal should be performed, which requires a fast and efficient signal processing method. Although a time-frequency analysis method can effectively remove signal spikes in most cases, the time-frequency analysis method generally has a large amount of calculation and cannot meet the requirements of real-time analysis. As a result, the time-frequency analysis method is only suitable for analyzing short-duration signals, and is not suitable for analyzing long-duration signals with a time unit of days that are often required to be analyzed in the field of civil structural health monitoring.

To improve the efficiency of removing spikes of long-duration SHM signals, in a paper “A wavelet-based despiking algorithm for large data of structural health monitoring” published by Xia Yunxia and Ni Yiqing in International Journal of Distributed Sensor Networks [2018, 14(12)], a method for first identifying a spike position with equal-scale wavelet transform, then performing the maximum overlap wavelet transform on part of a spike, and removing the spike by processing transformed wavelet coefficients is adopted. Compared with performing wavelet transform directly on a long-duration signal to remove a spike, the method first identifies a spike position, and then only processes a local signal of the spike, which greatly improves the calculation efficiency. However, it takes a certain amount of calculation time to use equal-scale wavelet transform in a spike identification step. Moreover, for spikes with a large difference in duration, due to different wavelet transform scales required, several steps are required for identification, which further reduces the signal processing efficiency.

### SUMMARY

In view of defects in the related art, the present invention provides a method and a system for quickly eliminating signal spikes of structural health monitoring in civil engineering. The method and system combine the advantages of a high calculation speed of a time domain method and high resolution of a time-frequency domain method, which can make an algorithm fast and accurate, and has good applicability to an SHM signal with complex time-frequency characteristics and a large amount of data.

A first objective of the present disclosure is to provide a method for quickly eliminating signal spikes of structural health monitoring in civil engineering. including the following steps:

(1) quickly identifying, by using a threshold method, a spike position in a time domain;

(2) extracting spike features in a time-frequency domain through wavelet transform for a signal within a set range near the spike position; and

(3) eliminating spike feature components in wavelet coefficients, and effectively eliminating a spike through inverse wavelet transform.

Further, the step (1) of quickly identifying, by using a threshold method, a spike position in a time domain includes specific steps:

(1-1) selecting appropriate thresholds for positive and negative signals respectively;

(1-2) screening points at which the positive signal is greater than a selected threshold and the negative signal is less than the selected threshold;

(1-3) obtaining a vertex according to an over-threshold point obtained by screening, that is, a potential position of a spike; and

(1-4) determining a spike timestamp according to the potential position of the spike.

Further, when the threshold is automatically selected in the step (1-1), considering that an SHM signal is very long and data fluctuates greatly in different periods of time, the threshold is capable of being selected in sections.

Further, the threshold in the step (1-1) is capable of being automatically selected according to statistical features of a signal.

Further, when the threshold is automatically selected in the step (1-1), a signal is capable of being selected according to a signal standard value when the signal obeys normal distribution, such as x̅+kσ for the positive signal and x̅−kσ for the negative signal (where x̅ is a signal mean value, σ is a signal standard value, k is capable of being an integer in a range of 3 to 5, and a specific value is determined according to an actual signal).

Further, when the threshold is automatically selected in the step (1-1), when the signal obeys skewed distribution, to prevent a threshold selected through a standard deviation from being too large, the threshold is capable of being selected according to a signal median, that is, a signal standard value σ in the method is replaced with \hat{σ}=median(|x|)/0.6745.

Further, the step (2) of extracting spike features in a time-frequency domain through wavelet transform includes specific steps:

(2-1) performing discrete wavelet transform on a signal within a set range near the spike position, and transforming the time domain signal to the time-frequency domain;

(2-2) in each frequency band after the wavelet transform, comparing each wavelet coefficient with a set quantity of wavelet coefficients before and after the wavelet coefficient, and screening out local maximum or minimum wavelet coefficients;

(2-3) selecting, by using the same method as the step (1-1), an appropriate threshold according to statistical features of wavelet coefficients, and further screening out local maximum or minimum wavelet coefficients in a set range; and

(2-4) searching for a chain of maximum or minimum wavelet coefficients in different frequency bands, that is, a spike feature.

Further, the spike in the step (2-4) is theoretically represented by a chain constituted by the maximum or minimum wavelet coefficients at the same moment in different frequency bands on a scale plane, but to avoid a large amount of calculation caused by searching for spike features at the same moment in all frequency bands, as long as a chain is constituted by maximum or minimum wavelet coefficients in adjacent frequency bands, the chain is regarded as a wavelet coefficient chain that represents the spike.

Further, the step (3) of effectively eliminating a spike includes specific steps:

(3-1) setting wavelet coefficients corresponding to the chain of local maximum or minimum wavelet coefficients to 0 in each frequency band after the wavelet transform;

(3-2) performing inverse wavelet transform on the wavelet coefficients in each frequency band processed above to obtain a despiked signal; and

(3-3) assembling a despiked local signal and other signals to obtain a despiked complete signal.

According to a second aspect, the present invention further provides a system for quickly eliminating signal spikes of structural health monitoring in civil engineering, including:

a spike identification module, configured to quickly identify a spike in a time domain and determine a timestamp of the spike;

a spike feature extraction module, configured to perform discrete wavelet transform on a signal within a set range near a spike position, and extract a chain of maximum or minimum wavelet coefficients as a spike feature; and

a spike eliminating module, configured to set a wavelet coefficient representing the spike to zero in a wavelet domain, and perform inverse wavelet transform to eliminate the spike.

Compared with the related art, the present invention has the following beneficial effects.

In the present invention, a spike position is first identified through a time-domain threshold method with a high calculation speed, and then a spike is eliminated by concentrating a high-resolution time-frequency method on a local signal of a spike, retaining wanted signal components while effectively removing the spike. The method is fast and accurate, provides a good signal preprocessing method for structural health monitoring in civil engineering, and can significantly improve the efficiency of structural health diagnosis.

### BRIEF DESCRIPTION OF THE DRAWINGS

FIG. 1 is a schematic flowchart of a method and a system for quickly eliminating signal spikes of structural health monitoring in civil engineering;

FIG. 2 is a time-domain diagram of a structural health monitoring signal in civil engineering with spikes;

FIG. 3 is a schematic diagram of selecting a threshold in sections and identifying a spike timestamp in a time domain; and

FIG. 4 is a time-domain diagram of a despiked example signal.

### DETAILED DESCRIPTION

It should be pointed out that the following detailed descriptions are all illustrative and are intended to provide further descriptions of the present invention. Unless otherwise specified, all technical and scientific terms used herein have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the present invention clearly dictates otherwise. In addition, it should be further understood that, terms “comprise” and/or “include” used in this specification indicate that there are features, steps, operations, devices, components, and/or combinations thereof.

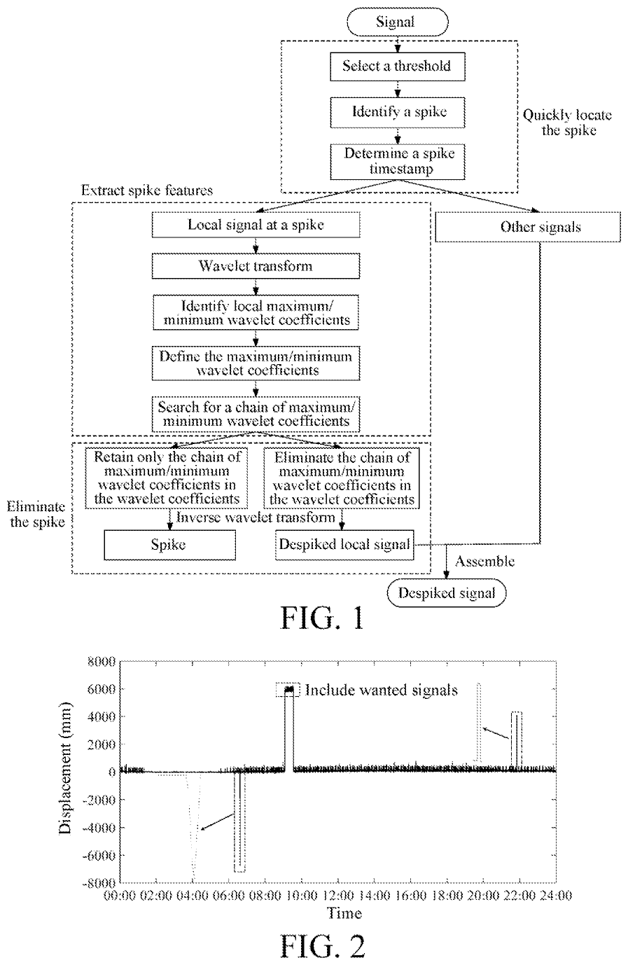

As shown in FIG. 1, an embodiment discloses a method for quickly eliminating signal spikes of structural health monitoring in civil engineering, which includes the following steps:

(1) quickly identifying, by using a threshold method, a spike position in a time domain;

(2) extracting spike features in a time-frequency domain through wavelet transform for a signal within a set range near the spike position; and

(3) eliminating spike feature components in wavelet coefficients, and effectively eliminating a spike through inverse wavelet transform.

Further, in this embodiment, the step (1) of quickly identifying, by using a threshold method, a spike position in a time domain includes specific steps:

(1-1) Select appropriate thresholds for positive and negative signals respectively. In the step, considering that spike features in two directions may be different, the positive and negative signals should be considered separately. When a threshold is automatically selected, considering that an SHM signal is very long and data fluctuates greatly in different periods of time, the threshold is capable of being selected in sections; and the threshold is capable of being automatically selected according to statistical features of a signal.

When the threshold is automatically selected, a signal is capable of being selected according to a signal standard value when the signal obeys normal distribution, such as x̅+kσ for the positive signal and x̅−kσ for the negative signal (where x̅ is a signal mean value, σ is a signal standard value, k is capable of being an integer in a range of 3 to 5, and a specific value is determined according to an actual signal).

Further, when the threshold is automatically selected in the step (1-1), when the signal obeys skewed distribution, to prevent a threshold selected through a standard deviation from being too large, the threshold is capable of being selected according to a signal median, that is, a signal standard value σ in the method is replaced with \hat{σ}=median(|x|)/0.6745.

(1-2) Screen points at which the positive signal is greater than a selected threshold and the negative signal is less than the selected threshold.

(1-3) Obtain a vertex according to an over-threshold point obtained by screening, that is, a potential position of a spike; if a value of a current point is greater than or less than values of two adjacent points, the point is a vertex.

(1-4) Determine a spike timestamp according to the potential position of the spike. If a value of a current vertex is greater than or less than values of all vertices within an adjacent period of time, a spike timestamp is at the vertex.

Further, the step (2) of extracting spike features in a time-frequency domain through wavelet transform includes specific steps:

(2-1) Perform discrete wavelet transform on a signal within a set range near the spike position, and transform the time domain signal to the time-frequency domain. In the step, to improve the efficiency of signal processing, the discrete wavelet transform is performed on only the signal within the set range near the spike position.

(2-2) In each frequency band after the wavelet transform, compare each wavelet coefficient with a set quantity of wavelet coefficients before and after the wavelet coefficient, and screen out local maximum or minimum wavelet coefficients.

(2-3) Select an appropriate threshold and retain the local maximum or minimum wavelet coefficients in the set range.

(2-4) Search for a chain of maximum or minimum wavelet coefficients in different frequency bands, that is, a spike feature. The spike in the step is theoretically represented by a chain constituted by the maximum or minimum wavelet coefficients at the same moment in different frequency bands on a scale plane, but to avoid a large amount of calculation caused by searching for spike features at the same moment in all frequency bands, as long as a chain is constituted by maximum or minimum wavelet coefficients in adjacent frequency bands, the chain is regarded as a wavelet coefficient chain that represents the spike.

Further, the step (3) of effectively eliminating a spike includes specific steps:

(3-1) Set wavelet coefficients corresponding to the chain of local maximum or minimum wavelet coefficients to 0 in each frequency band after the wavelet transform.

(3-2) Perform inverse wavelet transform on the wavelet coefficients in each frequency band processed above to obtain a despiked signal.

(3-3) Assemble a despiked local signal and other signals to obtain a despiked complete signal.

### Specific Embodiments

1) Thresholds are automatically selected in sections according to statistical features for positive and negative signals respectively. A signal is a segment every two hours, an analyzed signal obeys skewed distribution, and a threshold is selected according to a median. Because a spike value is very large, after trial calculation, k of 22 is taken. An observation signal is vertical displacement data of a part of a bridge deck system for a whole day, which includes three spikes, shapes and durations of the spikes are different from each other in the time domain, where a second spike includes a wanted signal, as shown in FIG. 2.

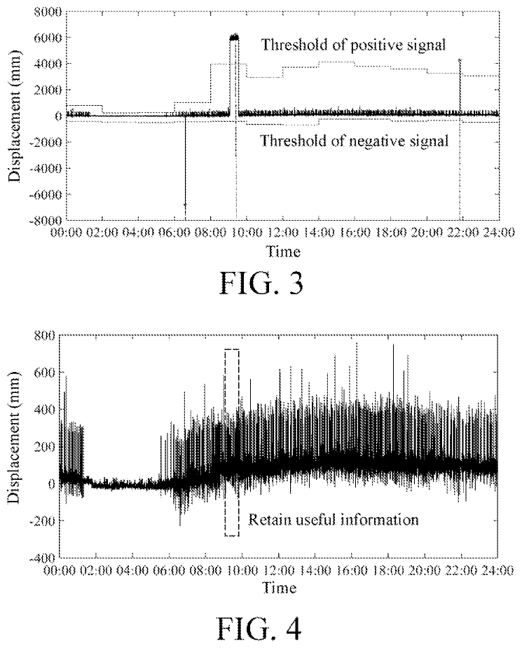

2) Points at which the positive signal is greater than a selected threshold and the negative signal is less than the selected threshold in each segment of a signal are screened, as shown in FIG. 3.

3) A vertex is obtained according to an over-threshold point obtained by screening; if a value of a current point is greater than or less than values of two adjacent points, the point is a vertex, that is, a potential position of a spike.

4) A spike timestamp is determined according to the potential position of the spike; if a value of a current vertex is greater than or less than values of all vertices within half an hour adjacent to the current vertex, a spike timestamp is at the vertex, as shown in FIG. 3.

In the steps 1) to 4), the time spent on identifying the spike timestamp is 0.08 seconds, but the time spent on identifying the same spike timestamp by using a wavelet method used in a paper “A wavelet-based despiking algorithm for large data of structural health monitoring” published by Xia Yunxia and Ni Yiqing in International Journal of Distributed Sensor Networks [2018, 14(12)] is 0.76 seconds. The analyzed signal has a sampling frequency of 2.56 Hz, a duration of 24 hours, and a total of 221,184 data points. The computer processors used are all Intel® Core i7-10710U CPUs. It can be seen that the method used in the present invention greatly improves a calculation speed.

5) Discrete wavelet transform is performed on a local signal within a total of an hour, namely, half an hour before and after a spike, and the time domain signal is transformed to the time-frequency domain.

6) In each frequency band after the wavelet transform, each wavelet coefficient is compared with two wavelet coefficients before and after the wavelet coefficient, and local maximum or minimum wavelet coefficients are screened out.

7) A threshold of 300 is selected according to statistical features of the wavelet coefficient, and corresponding local maximum or minimum wavelet coefficients are retained.

8) A chain of maximum or minimum wavelet coefficients in adjacent frequency bands, that is, a spike feature is searched for.

9) Wavelet coefficients corresponding to the chain of local maximum or minimum wavelet coefficients are set to 0 in each frequency band.

10) Inverse wavelet transform is performed on the wavelet coefficients in each frequency band processed above to obtain a despiked local signal.

11) A despiked local signal and other signals are assembled to obtain a despiked complete signal.

Different from a method for replacing a signal at a spike with a mean value, an interpolated value, or the like of adjacent signals, in the present invention, useful information is intactly retained after a spike is eliminated, as shown in FIG. 4. It can be seen that the present invention processes spikes more accurately.

When a time-frequency method used in the present invention directly processes an entire signal to remove spikes, a computer crashes. It can be seen that in the present invention, a spike position is first quickly identified, and then processing is concentrated on a local signal near the spike position, which greatly improves the calculation efficiency.

Further, an embodiment further provides a system for quickly eliminating signal spikes of structural health monitoring in civil engineering, including the following modules:

a spike identification module, configured to quickly identify a spike in a time domain and determine a timestamp of the spike;

a spike feature extraction module, configured to perform discrete wavelet transform on a signal within a set range near a spike position, and extract a chain of maximum or minimum wavelet coefficients as a spike feature; and

a spike eliminating module, configured to set a wavelet coefficient representing the spike to zero in a wavelet domain, and perform inverse wavelet transform to eliminate the spike.

The spike identification module, the spike feature extraction module, and the spike eliminating module correspond to the steps (1), (2), and (3) in the previous method. Therefore, a specific processing method of each module is the same as a step-by-step processing method under each step. Reference can be made to the previous content, and details are not repeated herein.

In the present invention, a spike position is first identified through a time-domain threshold method with a high calculation speed, and then a spike is eliminated by concentrating a high-resolution time-frequency method on a local signal of a spike, retaining wanted signal components while effectively removing the spike. The method is fast and accurate, provides a good signal preprocessing method for structural health monitoring in civil engineering, and can significantly improve the efficiency of structural health diagnosis.

The foregoing descriptions are merely preferable embodiments of the present disclosure, but are not intended to limit the present disclosure. The present disclosure may include various modifications and changes for a person skilled in the art. Any modification, equivalent replacement, or improvement made within the spirit and principle of the present disclosure shall fall within the protection scope of the present disclosure.

What is claimed is:

1. A method for quickly eliminating signal spikes of structural health monitoring in civil engineering, comprising the following steps:
(1) quickly identifying, by using a threshold method, a spike position in a time domain;
(2) extracting spike features in a time-frequency domain through wavelet transform for a signal within a set range near the spike position; and
(3) eliminating spike feature components in wavelet coefficients, and effectively eliminating a spike through inverse wavelet transform.

2. The method for quickly eliminating signal spikes of structural health monitoring in civil engineering according to claim 1, wherein the step (1) of quickly identifying, by using a threshold method, a spike position in a time domain comprises specific steps:
(1-1) selecting appropriate thresholds for positive and negative signals respectively;
(1-2) screening points at which the positive signal is greater than a selected threshold and the negative signal is less than the selected threshold;
(1-3) obtaining a vertex according to an over-threshold point obtained by screening, that is, a potential position of a spike; and
(1-4) determining a spike timestamp according to the potential position of the spike.

3. The method for quickly eliminating signal spikes of structural health monitoring in civil engineering according to claim 2, wherein when the threshold is automatically selected in the step (1-1), the threshold is capable of being selected in sections, and the threshold is capable of being automatically selected according to statistical features of a signal.

4. The method for quickly eliminating signal spikes of structural health monitoring in civil engineering according to claim 2, wherein when the threshold is automatically selected in the step (1-1), a signal is capable of being selected according to a signal standard value when the signal obeys normal distribution, such as x̅+kσ for the positive signal and x̅−kσ for the negative signal, wherein x̅ is a signal mean value, σ is a signal standard value, k is capable of being an integer in a range of 3 to 5, and a specific value is determined according to an actual signal; when the signal obeys skewed distribution, to prevent a threshold selected through a standard deviation from being too large, the threshold is capable of being selected according to a signal median, that is, a signal standard value σ in the method is replaced with \hat{σ}=median(|x|)/0.6745.

5. The method for quickly eliminating signal spikes of structural health monitoring in civil engineering according to claim 2, wherein in the step (1-3), if a value of a current point is greater than or less than values of two adjacent points, the point is a vertex.

6. The method for quickly eliminating signal spikes of structural health monitoring in civil engineering according to claim 2, wherein in the step (1-4), if a value of a current vertex is greater than or less than values of all vertices within an adjacent period of time, a spike timestamp is at the vertex.

7. The method for quickly eliminating signal spikes of structural health monitoring in civil engineering according to claim 1, wherein the step (2) of extracting spike features in a time-frequency domain through wavelet transform comprises specific steps:
(2-1) performing discrete wavelet transform on a local signal within a set range near the spike position, and transforming the time domain signal to the time-frequency domain;
(2-2) in each frequency band after the wavelet transform, comparing each wavelet coefficient with a set quantity of wavelet coefficients before and after the wavelet coefficient, and screening out local maximum or minimum wavelet coefficients;
(2-3) selecting an appropriate threshold and retaining a set quantity of local maximum or minimum wavelet coefficients; and
(2-4) searching for a chain of maximum or minimum wavelet coefficients in different frequency bands, that is, a spike feature.

8. The method for quickly eliminating signal spikes of structural health monitoring in civil engineering according to claim 7, wherein in the step (2-4), as long as a chain is constituted by maximum or minimum wavelet coefficients in adjacent frequency bands, the chain is regarded as a wavelet coefficient chain that represents the spike.

9. The method for quickly eliminating signal spikes of structural health monitoring in civil engineering according to claim 7, wherein the step (3) of effectively eliminating a spike includes specific steps:
(3-1) setting wavelet coefficients corresponding to the chain of maximum or minimum wavelet coefficients in the step (2-4) to 0 in each frequency band after the wavelet transform;
(3-2) performing inverse wavelet transform on wavelet coefficients in each frequency band processed in the step (3-1) to obtain a despiked signal; and
(3-3) assembling a despiked local signal and other signals to obtain a despiked complete signal.

10. A system for quickly eliminating signal spikes of structural health monitoring in civil engineering, comprising:
a spike identification module, configured to quickly identify a spike in a time domain and determine a timestamp of the spike;
a spike feature extraction module, configured to perform discrete wavelet transform on a signal within a set range near a spike position, and extract a chain of maximum or minimum wavelet coefficients as a spike feature; and
a spike eliminating module, configured to set a wavelet coefficient representing the spike to zero in a wavelet domain, and perform inverse wavelet transform to eliminate the spike.
